(19) United States
(12) Patent Application Publication
(10) Pub. No.: US 2024/0102349 A1
(43) Pub. Date: Mar. 28, 2024

(54) SOIL CORE COLLECTING TOOL AND METHOD

(71) Applicant: AGRICARBON UK LIMITED, Dundee (GB)

(72) Inventors: Stewart ARBUCKLE, Dundee (GB); Andrea LEESON, Dundee (GB); Artur Romero HAZAS, Dundee (GB)

(73) Assignee: AGRICARBON UK LIMITED, Dundee (GB)

(21) Appl. No.: 18/255,766

(22) PCT Filed: Dec. 2, 2021
(86) PCT No.: PCT/EP2021/084038

§ 371 Date: Jun. 2, 2023

(30) Foreign Application Priority Data
Dec. 3, 2020 (GB) 2019075.7

(51) Int. Cl. E21B 25/00; E21B 25/10

(52) U.S. Cl. CPC E21B 25/005; E21B 25/10

(57) ABSTRACT

A soil core collector assembly includes a sample tube (1) for receiving a core (16) of soil when fitted to a soil core collecting tool (30), and a core carrying tray (4) nestable in sliding engagement within the sample tube. The assembly can be used in a method of sampling soil including obtaining a core of soil by driving a soil core collecting tool into the earth and collecting the core in the sample tube (1) when the core carrying tray (4) is nested within. The core (16) is removed from the sample tube (1) by sliding it out on the core carrying tray (4). Alternatively, the core (16) is collected in the sample tube (1); the core carrying tray (4) is slid into nesting engagement with the sample tube; and then the core (16) is slid out of the sample tube (1) on the core carrying tray (4).

### FIELD

The present invention relates to tools for collecting and handling cores of soil from the earth, for analysis. Methods of collecting cores are also provided.

### BACKGROUND

Cores of soil, typically at depths of from 1 to 2 metres are taken for various analytical purposes including to determine the type and quality of the soil, in particular bulk density, mineral content, the nitrogen content and the organic and/or inorganic carbon content. Sampling techniques generally involve pushing or drilling a core collecting tool, including a sample tube into the ground.

A core of soil is collected in the sample tube and subsequently removed from the tool for inspection and/or analysis. To enable useful results, it is important that a sufficient number of cores are taken across the area being surveyed and that the cores are handled carefully and in a consistent manner throughout the procedure.

Core collecting tools that can consistently and accurately retrieve cores for analysis are required to enable a proper understanding of soil structure and content.

### SUMMARY

According to a first aspect, the present invention provides a soil core collector assembly comprising:
a sample tube for receiving a core of soil when fitted to a soil core collecting tool; and
a core carrying tray nestable in sliding engagement within the sample tube.

The core carrying tray is nestable within the sample tube i.e. the tray conforms closely to the inner surface of the sample tube, in use.

The core carrying tray nests in sliding engagement within the sample tube in use. Conveniently, the core carrying tray can be nested within the sample tube as a soil core is collected by a suitable tool. The assembly of sample tube and core carrying tray, with a collected core present, may be capped at either end of the sample tube for storage and transport purposes if required (in the same manner as is done for cores collected in a conventional arrangement).

The core carrying tray can be slid out of the sample tube whenever desired, carrying the collected soil core with it.

In some uses of the assembly (described hereafter), the core carrying tray can, as an alternative, be slid into a sample tube already filled with a soil core. The tray can then be slid out, carrying the soil core with it.

The use of the core carrying tray in the assembly can allow removal of a soil core from a sample tube, with minimal disturbance to the core. For example, avoiding mixing layers within the core. This can occur where the core is pushed out of a sample tube, with a rod, auger or the like. This can be especially important when the core is of a non-cohesive (e.g. sandy) soil. For further example, a particular problem may be compaction of the core, which can interfere with or even invalidate bulk density measurements. Furthermore, the core carrying tray avoids the need to cut open the sample tube when it is desired to leave the core as undisturbed as possible. Thus, the tube and tray assemblies of the invention can be reusable and so economic in use. Where a large soil sampling exercise is being undertaken the use of the core carrying trays can allow rapid and reproducible removal of the soil cores from the collecting tools employed.

Furthermore, when the core is slid out from the sample tube on the tray, a surface of the (generally undisturbed) core is exposed along the length of the tray. This allows close visual inspection or spectroscopic analysis of any part of or of all of the sample, whilst it is still undisturbed. If desired the core can be moved, on its tray from one location to another, for example from a location where a spectroscopic analysis is carried out to another where a sample of the core is taken for a chemical analysis,

Further advantages arise where the core is to be analysed by other physical and/or chemical methods, such as the combustion analysis used to determine carbon content (organic and/or inorganic) of a soil. Such an analysis typically involves taking cores, drying them and then processing the dried material through steps such as blending, sieving and pulverising; before testing representative aliquots in an analyser for carbon content.

The presentation of the cores on the core carrying tray allows cores to be readily divided into samples, with the depth at which the sample was originally present in the ground accurately known. Thus, detailed analysis of soil cores can be obtained together with accurate data of differences in content between layers at different depths within the soil, if required.

The sample tube may be of the conventional type employed in soil core collecting tools, i.e. a cylindrical tube, typically of plastic or metal. Alternative shapes of sample tube, for example square in cross section, are also contemplated.

The core carrying tray may be of a generally part cylindrical tube shape, for example a semi-cylindrical tube that is sized to nest—with its outer surface in contact with or in close proximity to the inner surface of a cylindrical sample tube.

A semi-cylindrical tube shaped tray nests within half the circumference of the inside surface of the sample tube. Other part cylindrical tube shapes may be employed for the tray, for example from between one quarter to three quarter part cylinder tube shapes.

The core carrying tray may be of generally the same length as the sample tube.

The core carrying tray may be of metal or plastic. Conveniently the sample tube and the core carrying tray may be of a plastics material, such as a polyethylene terephthalate glycol (PETG). Such materials can be suitably durable and inert for the task of soil core collecting and can be transparent, allowing viewing of the soil core even when it is within the sample tube.

The core carrying tray is removed from the sample tube by sliding it out. To retain the core on the tray the tube should be oriented so that the tray is beneath the core. For example, the sample tube may be held or placed in a generally horizontal orientation and rotated as required to have the tray underneath the core. Alternatively, the tube may be held to prevent rotation, and the tray rotated within the tube. This orientation may be done visually. However, even where the sample tube is transparent, it may be difficult to see the orientation of a tray nested within, especially if the ground being sampled is cohesive, e.g. a heavy clay.

Therefore, the assembly may be provided with means for determining the orientation of the tray when nested within the sample tube.

For example, the core carrying tray may be made visible by extending beyond one end of the sample tube when the parts are nested together. However, such an arrangement may not fit within existing soil sampling tools making use of sample tubes. For further example an end of the core carrying tray may include a feature such as a notch a protrusion, an indentation or an aperture that is readily seen, or can be detected by machine, or can be located when using a tool to remove the tray from the sample tube.

As an alternative or additional feature, the core carrying tray and sample tube may be formed so that the tray will only nest within the tube when they are in a particular orientation with respect to each other. The sample tube and/or the tray may then be provided with at least one indicia showing the position of the tray relative to the tube.

For example, a sample tube and core carrying tray assembly may have a one or more protrusions provided on the inner surface of the tube that hold the tray in a particular orientation with respect to the circumference of the tube (by preventing rotation of the tray within the tube). A visible marking on the outer surface of the tube can indicate the orientation of the tray within the tube. As an alternative to a visual indicium, the tube and/or the tray may be provided with one or more indicia providing orientation information that is machine readable. For example, a wireless arrangement such as an RFID tag or NFC tag may be employed.

Where a core carrying tray is to be employed with known sample tubes, the core carrying tray may be provided with one or more indicia that enables its orientation to be determined. For example, one or more NFC or RFID tags may be employed, provided on or in the material of the tray.

Conveniently indicia provided with a core carrying tray may be placed at or on an end of the tray. This can allow easier reading (visually or by machine). However, where a wireless readable marking such as an NFC or RFID tag is used it can be provided in or on the material of the tray anywhere along its length as an alternative to at or on an end of the tray. Where a tray is part cylinder tube in form, a wireless readable tag may be placed at the intended lowest point of curvature, of the tray.

As a yet further example of means for determining the orientation of the tray, the tray may be provided with one or more metallic components (if plastic) or magnets. A metal portion or magnet can readily be detected with a suitable electronic detector to indicate orientation of the tray within a sample tube. Magnets or ferromagnetic metal portions could even be used in conjunction with an electromagnet to rotate a sample tube into the required orientation (e.g. on a table where the tray is to be slid out of the sample tube. Other means may be used to orient the tray when it is contained within the sample tube. For example, a feature such as a protrusion, a slot, an aperture or a groove in an end of the tray may allow engagement with a tool which can be used to rotate the tray and/or the sample tube. This can allow subsequent sliding out of the tray with the core sample sitting on it. For example, an elongate slot in an end of a tray may be engaged with a tool having an end (akin to a standard screwdriver end) that fits into the slot. Rotation of the tool rotates the tube and tray assembly, or just the tray if the tube is held in a fixed position.

In use of the soil core collector assembly of the invention a soil core is collected in the sample tube and the core is subsequently removed from the sample tube by sliding out the core carrying tray. The core carrying tray may be slid out of the sample tube by means of a suitable tray removal tool inserted into an end of the sample tube and into contact with the corresponding end of the tray. The tray can be pushed out of the other end of the sample tube, carrying the soil core with it. This can be done either by pushing the tool into the sample tube or by moving the sample tube relative to the (held in place) tool. The tray removal tool may also be used to orient the tray as described above. The tray removal tool may be powered, for example by comprising a piston driving into the sample tube. The tray removal tool may be part of an automated system for removing core carrying trays. An automated system can be useful when a large number of soil cores are to be processed.

The end of the tray contacted by the tool employed may simply be an edge of the tray e.g. the part circular edge of a tray that has the form of a part cylindrical tube. However, to ensure that the core is removed from the sample tube with the tray, especially when a core is of a non-cohesive soil, such an arrangement may require the use of a tool that engages the end of the tray and contacts all or substantially all of the corresponding end face of the core. For example, the tool may have a circular face that is sized to fill substantially the whole of the cross section area of the sample tube.

Alternatively, the tray may be provided with an end that extends across at least part of the cross section of the sample tube when nested within it. Such an end can contact the end face of a core in use and is in turn contacted by the tool employed to slide the tray out of the sample tube. This can have the advantage of keeping the collected core more contained and may assist in ensuring that substantially the whole core is slid out of the sample tube with the tray. Thus, a part cylindrical tube core collecting tray may have a circular or substantially circular end that fills or substantially fills the cross section of the sample tube of the assembly. The end may be provided with one or more apertures that may act as a vent when the core collection is being carried out. The end may have an aperture that is a central hole. Such an aperture can allow access for tool components e.g. centre rods that may be employed in some sampling methods.

Where a core carrying tray has an end that extends over part or all of the cross section of the sample tube, that end will be placed away from the cutting edge of a soil core collecting tool in use. The opposite end will typically not have such a feature as that would act to prevent soil being collected in the sample tube as it advances into the ground.

Conveniently, where a core carrying tray has an end extending over part or all of the cross section area of the sample tube, that end may carry one or more indicia to indicate the orientation of the tray and/or to provide information regarding the sample. Such indicia may be one or more of barcodes, QR codes, RFID tags and NFC tags. For example, NFC tags may be employed to identify the sample and all data associated with it, for example location and number etc. and/or to provide a signal in respect of tray orientation.

Where orientation of a core carrying tray is to be established visually (e.g. by human eye or a camera based automated or part automated system) the one or more indicia may simply be a visible marking on an end of the tray. For example, an end of a tray extending over part or all of the cross section area of an associated sample tube may be provided with a readily visible marking such as a contrasting pattern e.g. of black and white colouring.

According to second aspect, the present invention also provides a core carrying tray for soil cores. The core carrying tray is nestable in sliding engagement with a sample tube of a soil core collecting tool and can comprise any or all of the features discussed herein with respect to core carrying trays employed with other aspects of the invention.

According to a third aspect the present invention provides a method of sampling soil comprising:
obtaining a core of soil by driving a soil core collecting tool into the earth and collecting the core in a sample tube contained within the tool; and either
removing the core from the sample tube by sliding it out on a core carrying tray that was nested within the sample tube during collection: or
removing the core from the sample tube by sliding a core carrying tray into nesting engagement with the sample tube, and then sliding the core out of the sample tube on the core carrying tray.

The method may make use for the soil core collector assembly of the first aspect of the invention. The method may make use of the core carrying tray of the second aspect of the invention.

Use of the method where the core carrying tray is nested within the sample tube during sampling is convenient as the tray is ‘pre-loaded’ in the sample tube when it is empty. When the alternative option in the method is employed, the tray has to be slid into a sample tube already filled with a soil core. To that end a front edge of the core carrying tray, for example the end of a part cylindrical tube may be formed as a taper (i.e. sharpened) to aid sliding insertion into a sample tube full of soil.

Where the core carrying tray is nested within the sample tube during sampling, the sample tube and associated tray may be fitted to a soil core collecting tool in a generally conventional way. For example, one end of the sample tube is fitted to a core cutting tool part (sometimes called a ‘shoe’) that takes the form of a cylinder with a cutting edge distal to the sample tube and having a passage therethrough for soil cores. The other end of the sample tube is connected to a drive rod or tube. Driving the assembled sampling tool into the soil results in a core passing through the cutting tool part into the sample tube. The passage through the shoe is generally of a slightly smaller diameter than the inside diameter of the sample tube. Thus, the core carrying tray can be held in position within the sample tube by one end resting on the proximal end of the cutting tool. The other end of the core carrying tray may be similarly located with respect to the drive rod or tube. If desired a tool cutting part may be provided with a feature such as a groove on its proximal end that accepts an end of the core carrying tray. Similarly, a drive rod may be provided with a feature to aid in holding the other end of the core carrying tray.

Other arrangements of core collecting tools can make use of the invention. For example, where plastic sample tubes are employed soil core collecting tools typically have an outer metal tube that mounts the core cutting shoe and the plastic sample tube is held within the outer metal tube. The core being cut passes through the shoe into the sample tube which has an end held against the shoe. In accordance with the invention such arrangements can be used, the core carrying tray nests within the plastic sample tube that is in turn held within the outer metal tube.

According to a fourth aspect the present invention provides a soil core collecting tool including a soil core collector assembly in accordance with the first aspect of the invention.

### BRIEF DESCRIPTION OF THE DRAWINGS

FIG. 1a shows a sample tube in schematic perspective:

FIG. 1b shows a core carrying tray for fitting inside the sample tube of FIG. 1a;

FIG. 1c shows an end view of the core carrying tray of FIG. 1b;

FIG. 2a shows, in schematic perspective, a soil core in a soil core collector assembly;

FIG. 2b shows a part view of a core carrying tray being slid out of a sample tube with a soil core;

FIGS. 3a, 3b, 3c, 3d, 3e and 3f show views of the ends of core carrying trays; and

FIG. 4 shows in schematic cross section the core cutting end of a soil core collecting tool.

### DETAILED DESCRIPTION OF THE DRAWINGS

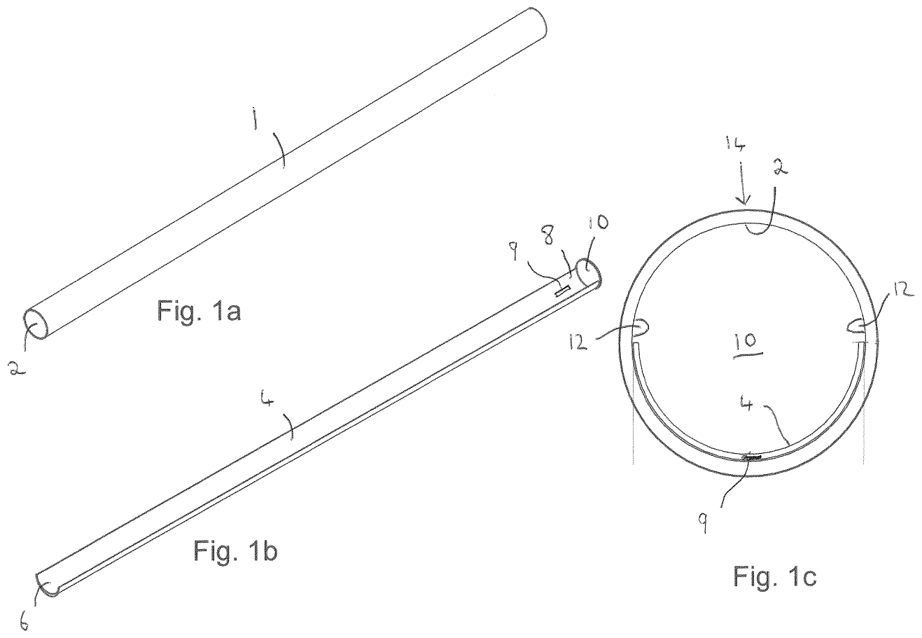

FIG. 1a shows a sample tube 1. In this example the sample tube is transparent and is formed as a cylindrical tube with an inner surface 2. Such tubes are employed in known soil sample systems to collect a core of soil when driven into the ground as part of a soil core collecting tool arrangement.

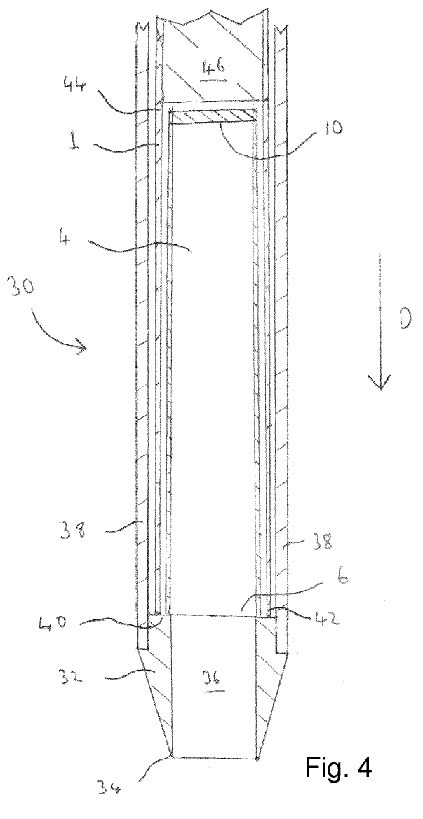

Typically, in prior art core collection, the tube 1 is fitted within an outer metal tube having a core cutting shoe at one end. (an arrangement illustrated further below with respect to an arrangement of the invention shown in FIG. 4).

To collect a core, sample tube 1 is carried in a core collecting tool that is manually, or often more conveniently, mechanically, driven into the ground. After retrieval of the tube 1 from its outer metal tube, the core sample contained within is removed by pushing it out of the tube or by cutting the tube open along its length.

FIG. 1b shows a soil core carrying tray 4, that together with a tube 1 (such as that of prior art FIG. 1a) constitutes a soil core collector assembly of the invention. Tray 4 takes the form of a part cylindrical tube, in this example a semi cylindrical tube. One end 6 of the tray 4 is fully open, having a part circular edge. The other end 8 of the tray in this example is provided with an end that extends across the cross section of the sample tube, when the tray 4 is nested within the tube 1 i.e. the tray includes a circular end 10. Near end 8 a wireless readable tag 9 is placed at the bottom of the curvature of the tray (see also FIG. 1c). The tag 9 may be an RFID or an NFC tag. The tag can be used to carry used to identify the sample in a logging system and/or to indicate the orientation of a tray in use.

The tray 4 is dimensioned to nest within sample tube 1. As illustrated in schematic end view FIG. 1c the tray 4 conforms closely to the inner surface 2 of tube 1 when fitted inside it. Also shown in FIG. 1c are optional inwards directed protrusions 12 in the wall of tube 1 that can be used to fix the orientation of the tray 4. In this example a marking is placed on the exterior of the tube 1 at position 14 to indicate the top of the tube, when the tray 4 is at the bottom i.e. in position for sliding out of the tube when loaded with a soil core sample. The marking at position 14 is not required if other means are employed to establish orientation of the tray 4.

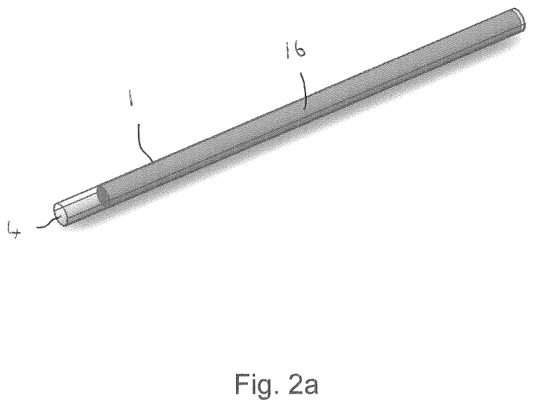

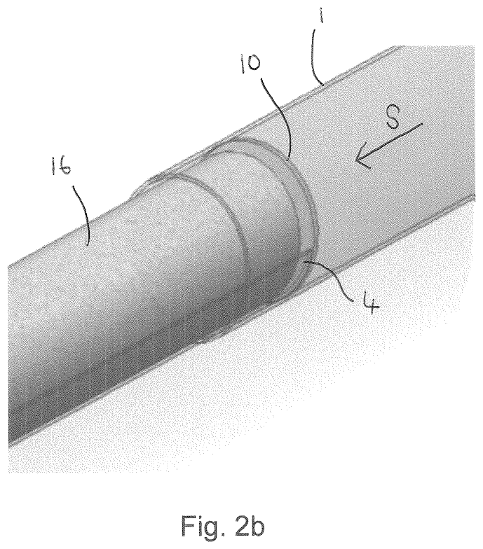

FIG. 2a shows the tray 4 inside the tube 1 after the assembly has been used to collect a core 16 of soil.

In FIG. 2b a magnified view shows the situation where the tray 4 has been largely slid (as suggested by arrow S) out of the tube 1 by application of a tool such as a rod to the end 10. The core 16 is about to be out of the tube 1, sitting in the tray 4. The core 16 will then be exposed along its full length for analysis, sampling and/or further processing. For example, dividing into samples for drying blending and analysis e.g. combustion analysis for determination of carbon content.

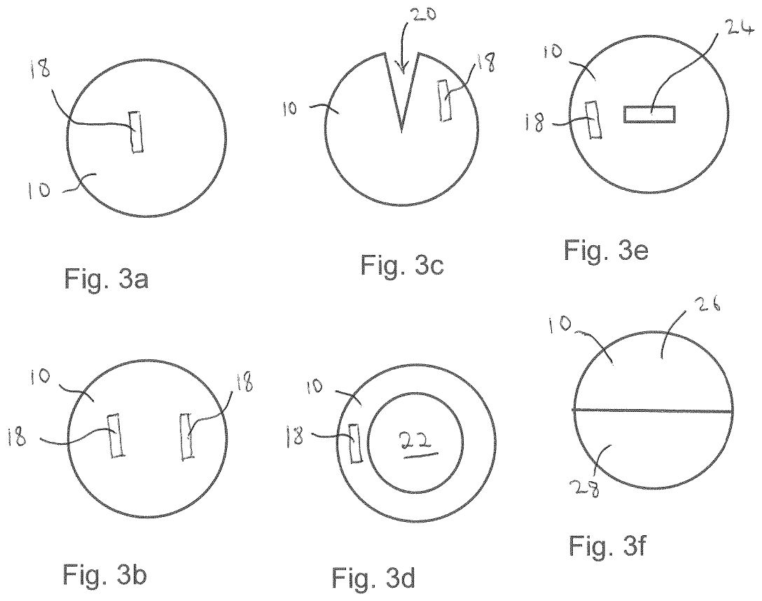

FIGS. 3a, 3b, 3c and 3d show various optional arrangements for ends 10 of core carrying trays.

In FIG. 3a a circular end 10 such as depicted in use in FIG. 2b is fitted with an indicium such as a bar code, NFC or RFID tag. The indicium can be used to identify the sample in a logging system and/or to indicate the orientation of a tray in use. A similar end 10 in FIG. 3b features two indicia. Where the indicia are read by machine (e.g. NFC or RFID tag) the use of more than one indicating feature may aid in determining orientation.

In FIG. 3c the end 10 includes a notch feature 20 which itself can be used to indicate orientation of a tray. A tool for sliding a tray fitted with end 10 may include a feature that locates in notch 20.

In FIG. 3d the end 10 has a circular aperture 22. This can allow passage of rods or tubes during use in a soil core sampling tool arrangement.

In FIG. 3e the end 10 has an aperture in the form of a slot 24 which can be engaged with a suitable tool having an end that fits in the slot. Such an arrangement can be employed to rotate a tray fitted with this end, or a tray and sample tube assembly.

In FIG. 3f the end 10 is divided into two portions. One portion 26 may be coloured white the other portion 28 black. These contrasting coloured portions may be used to determine (by eye, camera or other device) the orientation of a tray.

FIG. 4 shows in schematic cross section the end of a soil core collecting tool 30. The tool includes a cutting shoe 32 which is generally of a truncated cone shape with a distal soil core cutting edge 34 and a passage 36 therethrough. The shoe 32 is screw fitted to a tube 38, typically of metal, for driving into the ground as suggested by arrow D.

Within the outer tube 38 a sample tube 1 has been placed, together with a semi-cylindrical core carrying tray 4 that includes a circular end 10. The other end 6 of the core carrying tray 4 is open, having a semi-circular edge that rests on the proximal end 40 of the cutting shoe 32 (as does the corresponding end 42 of the sample tube 1).

As shown in this example, the sample tube 1 and core carrying tray 4 assembly may be held at their other ends (10, 44) by use of a rod 46 fitting into the sample tube end 44.

In use, the depicted arrangement is driven into the ground (direction D) and a soil core collected within the sample tube 1 and tray 4 assembly. After retrieval from the ground and removal of the assembly from outer tube 38, a collected soil core can be slid on tray 4 from sample tube 1 as discussed above.

1. A soil core collector assembly comprising:
a sample tube for receiving a core of soil when fitted to a soil core collecting tool; and
a core carrying tray nestable in sliding engagement within the sample tube.

2. The assembly of claim 1 wherein the sample tube is cylindrical.

3. The assembly of claim 1 wherein the core carrying tray is of a part cylindrical tube shape.

4. The assembly of claim 3 wherein the core carrying tray is of a semi-cylindrical tube shape.

5. The assembly of claim 1 wherein the sample tube and the core carrying tray are of a plastics material.

6. The assembly of claim 1 wherein the core carrying tray is of generally the same length as the sample tube.

7. The assembly of claim 1 wherein the core carrying tray extends beyond one end of the sample tube when the tray and tube are nested together.

8. The assembly of claim 1 further comprising means for determining the orientation of the core carrying tray when nested within the sample tube.

9. The assembly of claim 8 wherein the core carrying tray is provided with one or more indicia that enables its orientation to be determined.

10. The assembly of claim 9 wherein the one or more indicia is/are an NFC or RFID tag, a barcode or a QR code.

11. The assembly of claim 9 wherein the one or more indicia is/are placed at or on an end of the core carrying tray.

12. The assembly of claim 9 wherein an end of the core carrying tray includes at least one of: a notch, a protrusion, an indentation, an aperture or a contrasting pattern as the one or more indicia.

13. The assembly of claim 1 wherein the core carrying tray has an end that extends across at least part of the cross section of the sample tube when the tray is nested within the tube.

14. The assembly of claim 13, wherein the core carrying tray has a circular end that substantially fills the cross section of the sample tube of the assembly.

15. The assembly of claim 14 wherein the circular end is provided with an aperture.

16. The assembly of claim 1 wherein the core carrying tray and sample tube are formed so that the tray will only nest within the tube when the tray and the tube are in a particular orientation with respect to each other.

17. The assembly of claim 16 wherein at least one of the sample tube and the core carrying tray includes an indicium showing the orientation of the tray relative to the tube.

18. The assembly of claim 1 wherein at least one of the core carrying tray and the sample tube is provided with one or more metallic components or magnets.

19. A method of sampling soil comprising:
obtaining a core of soil by driving a soil core collecting tool into the earth and collecting the core in a sample tube contained within the tool; and either
removing the core from the sample tube by sliding it out on a core carrying tray that was nested within the sample tube during sampling: or
removing the core from the sample tube by sliding a core carrying tray into nesting engagement with the sample tube, and then sliding the core out of the sample tube on the core carrying tray.

20. A soil core collecting tool including a soil core collector assembly in accordance with claim 1.

21. A core carrying tray for soil cores that is nestable in sliding engagement with a sample tube of a soil core collecting tool.
